(19) United States
(12) Patent Application Publication
(10) Pub. No.: US 2009/0008228 A1
(43) Pub. Date: Jan. 8, 2009

(54) POWER SAVING DEVICE FOR POWER SOURCE

(76) Inventors: Ming-Tsai WANG, Dongguan (CN); Jia MA, Dongguan (CN); Haijun LUO, Dongguan (CN)

Correspondence Address: MATTHIAS SCHOLL, 14781 MEMORIAL DRIVE, SUITE 1319, HOUSTON, TX, 77079, US

(21) Appl. No.: 12/135,161

(22) Filed: Jun. 7, 2008

(30) Foreign Application Priority Data
Jun. 7, 2007 (CN) 200720120593.0

(51) Int. Cl. H01H 3/16

(52) U.S. Cl. 200/61.58 R; 398/111

(57) ABSTRACT

The present invention teaches a power saving device comprising a power saving circuit, said power saving circuit comprises a microprocessor (U1), an infrared receiving module, a relay, an AC-DC power source, a setup key, wherein said U1 is connected to a buzzer (SP1) via a triode (Q1), and to the setup key, and to the relay via a triode (Q2), and is connected to the infrared emitting module, the infrared receiving module, and the LED (D1) via a triode (Q3). By pushing the setup key, the microprocessor of the power saving device can read and store the infrared code, and controls to switch on or off the relay according to the codes, the relay is connected in series with the line or neutral wire of the power source.

### CROSS-REFERENCE TO RELATED APPLICATIONS

This application claims priority benefits to Chinese Patent Application No. 200720120593.0 filed on Jun. 7, 2007, the contents of which are incorporated herein by reference.

### BACKGROUND OF THE INVENTION

1. Field of the Invention

The invention relates to power source, and more particularly, to a power saving device.

2. Description of the Related Art

Nowadays, most power sockets for household appliances are designed with manual operated switch, however, the function of the switch to shut off the power of the appliances is not applied for a variety of reasons. With the maturation of the infrared remote controlling technology, the infrared remote controlling apparatus has been popular for use for household appliances, generally, an electrical appliance is in a standby status when using a remote controller to power the appliance off, thus not only the electric power is wasted and the useful life of the appliance is shortened, but also unsafe factors for the appliance are increased due to the variation of the voltage or the attack of the thunder and lightning.

A China inventive patent with an application No. of 200620050759.1 disclosed an infrared remote controlling power socket, which comprises an infrared receiving apparatus, a processing circuit, and a control circuit, wherein the control circuit is mainly comprised of a relay serving to control the power on or off of the power socket. Its operational principle is: when receiving a manual or remote controlling signal, the processing and control circuits start to work, the stick relay controls the on and off of the switch so as to power on or power off power socket. However, the remote controller can only work instantaneously and is lack of intelligence, and thus can not meet the automatic requirement of modern society; meanwhile, this patent specifies a particular remote controller, and can not use a normal remote controller such as for television or air conditioner at home. Therefore, it is beneficial to develop an intelligent power saving device, wherein a normal remote controller can be applied to control synchronously the power saving device, so that the power source can be powered on or off simultaneously when the user switches off the television or air conditioner or other infrared remote controlling appliances.

### SUMMARY OF THE INVENTION

Therefore, it is an objective of the present invention to provide a power saving device for power source, wherein a normal infrared remote controller can be applied to control directly the relay of this power saving device. A setup key is set for the power saving device, by which the MCU (microprocessor control unit) can store and identify the infrared signal from a certain key of the remote controller; the infrared signal is firstly converted to an electronic code through an infrared receiving module, the electronic code is stored by the MCU. When pushing the same key on the remote controller, the MCU identifies this signal and switches the relay off; when pushing the same key again, the MCU then switches the relay on. By the times of pushing the setup key continually, a certain number of keys on the remote controller can be determined to control a certain number of outlets of the power socket. Meanwhile, in response to the function by pushing only one key on the remote controller to power on or power off the appliances, an infrared emitter can be installed on the power saving device, the microprocessor can control the infrared emitter for remote controlling operation.

To achieve the above objective, there is provided a power saving device, comprising: a microprocessor (U1), an infrared receiving module, a relay, a AC-DC power supply, an internal memory in microprocessor(U1) or external memory, wherein the U1 is connected respectively to the infrared receiving module, the relay, the AC-DC power supply, and the setup key. An infrared signal is emitted by pushing any key on the remote controller, and then the infrared receiving module read this signal and converts it to an electronic code, which is stored in memory by the U1 by pushing the setup key simultaneously. When the device receives the electronic code again, the U1 can execute the command to switch on or switch off the relay. The power terminal of the relay is connected in series with the line or neutral wire of the power source, so that when the relay is switched off, the appliances connected to the power saving device will be powered off simultaneously, the power saving device is then ready to receive the infrared command. By setting a setup key, an infrared receiving module, and a relay connected to the U1, the U1 can read and store the infrared code when pushing the setup key, and executes the command to switch on or switch off the relay according to the stored codes. The power terminal of the relay is connected in series with the power socket.

In certain embodiments of the present invention, optionally, said U1 is connected with a buzzer.

In certain embodiments of the present invention, optionally, said U1 is connected with an indicator (light emitted diode)

In certain embodiments of the present invention, optionally, said U1 is connected with an infrared emitting module.

In certain embodiments of the present invention, optionally, said U1 is connected with a wireless emitter.

In certain embodiments of the present invention, said relay is connected to the plugboard.

In certain embodiments of the present invention, the power connection wires of the outer power source connected with said device are connected with a power switch, an overcurrent protector, a circuit breaker, and a fuse.

In certain embodiments of the present invention, the number of said device is at least one, wherein the setup key and buzzer are shared.

In certain embodiments of the present invention, said infrared receiving module is covered with a shell and is set with an adhesive disc.

In certain embodiments of the present invention, in said circuit, U1 is connected to the buzzer (SP1) via a triode (Q1), and to the setup key, and to the relay via a triode (Q2), and is connected to the infrared receiving module, and the LED (D1) via a triode (Q3).

As a result, the power saving device of the present invention provides a good electricity saving efficiency, has a simple structure, and is easy to use.

### BRIEF DESCRIPTION OF THE DRAWINGS

FIG. 1 illustrates an electrical block diagram of the present invention, and

FIGS. 2-4 illustrate an electrical schematic diagram of FIG. 1 of the present invention.

The reference numbers of the various parts shown in the drawings are listed below, in which relay corresponds to the number 1; infrared emitting module—2; indicator (D1)—3; mnemonic—4; buzzer—5; setup key—6; microprocessor—7; infrared receiving module—8; and power supply—9.

### DETAILED DESCRIPTION OF THE EMBODIMENTS

The present invention will hereinafter be described further according to the embodiments.

The power saving device of the present invention comprises a microprocessor (including memory) 7, an infrared receiving module 8, a relay 1, an AC-DC power supply 9, a setup key 6, a buzzer 5, and an infrared emitting module (or wireless emitter) 2. An infrared signal is emitted by pushing any key on the remote controller, and is read and converted to an electronic code by the infrared receiving module 8, the electronic code is then read and stored by the microprocessor 7 by pushing the setup key 6. When the device receives the electronic code again, the microprocessor can execute the command to switch on or off the relay, wherein the power terminal of the relay is connected in series with the live wire of the power source, so that the appliances connected to the power saving device can be powered off simultaneously when the relay is switched off. Besides, a setup key, an infrared receiving module, and a relay, which are connected to a monolithic processor, are also set on the device. By pushing the setup key, the microprocessor reads and stores the infrared code, and then executes the command to power on or power off the relay according to the infrared code. The relay is connected in series with the live wire or neutral wire of the power supply.

In the present invention, the power connection wires of the outer power source connected with the device are connected with a power switch, an overcurrent protector, a circuit breaker, and a fuse.

In the present invention, at least one power saving device is installed on a power supply system, wherein the setup key and buzzer are shared.

When installing the power saving device in the plugboard, the power supply of the device is connected to the power lines of the plugboard, the power supply of the sockets are connected in series with the power terminal of the relay of the device.

In the present invention, the infrared receiving module is connected with the monolithic processor via a set of wires, and is covered by a shell and is set with an adhesive disc.

An infrared emitter is set and is connected with the microprocessor, which controls the infrared emitter to emit infrared signal.

Alternatively, a wireless emitter can be set and can be connected with the microprocessor, which controls the wireless emitter to emit wireless signal.

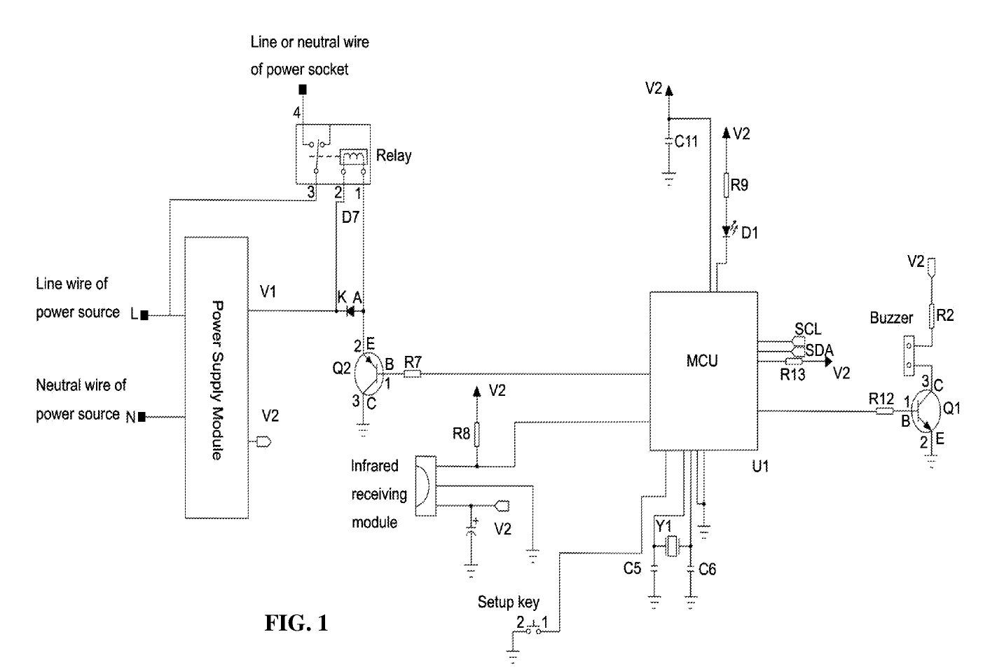

As shown in FIG. 1, the power saving device of the present invention comprises a relay 1, an infrared receiving module 8, an infrared emitting module 2, an indicator 3, a setup key 6, a buzzer 5, and a microprocessor (U1) 7, wherein the microprocessor U1 includes a mnemonic 4. The U1 is connected to one end of the electromagnetic coil of the relay 1 via a resistor R7 and a triode Q2, the other end of the electromagnetic coil is connected to the output terminal V1 of the AC-DC power supply 9, the two ends of the electromagnetic coil are connected by a diode D1, the power terminal of the relay 1 is connected with the live wire of the sockets, the switch of the power terminal of the relay 1 is connected with the live wire of the power line; The U1 is connected to the infrared emitting module 2 via a resistor R92 and a triode Q3, the output terminal V2 of the AC-DC power supply 9 is connected to the infrared emitting module 2 via a resistor R91; the output terminal V2 is also connected to the U1, and is grounded via a capacitor C11, the indicator 3 is a light emit diode and is connected directly to the U1, the output terminal V2 of the AC-DC power supply 9 is connected to the other end of the light emit diode via a resistor R9; the monolithic processor is connected with the buzzer 5 via a resistor R12 and a triode Q1, the output terminal V2 of the AC-DC power supply 9 is connected with the buzzer 5 via a resistor R2; the U1 is connected with the setup key 6, the other end of the setup key 6 is grounded; the U1 is connected with the infrared receiving module 8 directly, the output terminal V2 of the AC-DC power supply 9 is connected to the infrared receiving module 8 via a resistor R8 or a capacitor; the AC-DC power supply 9 is connected with the power lines directly.

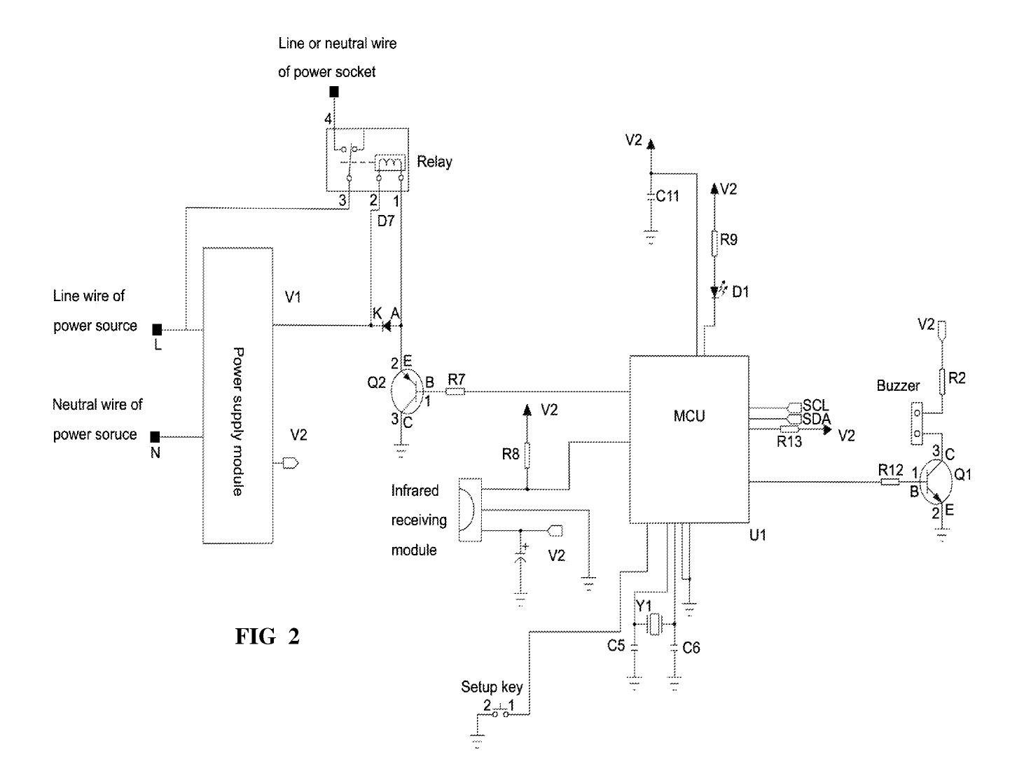

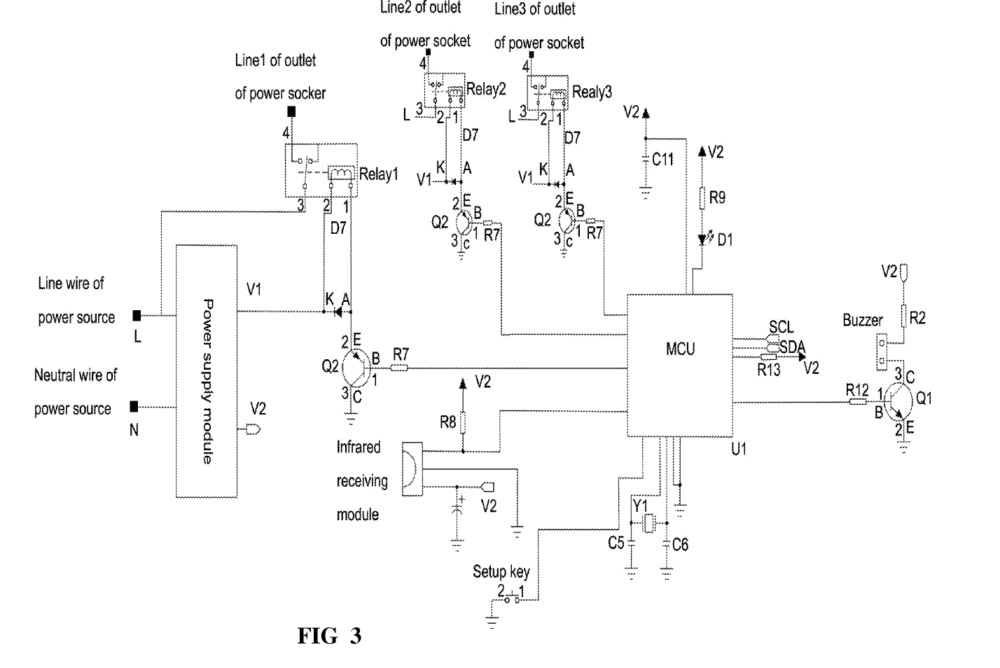

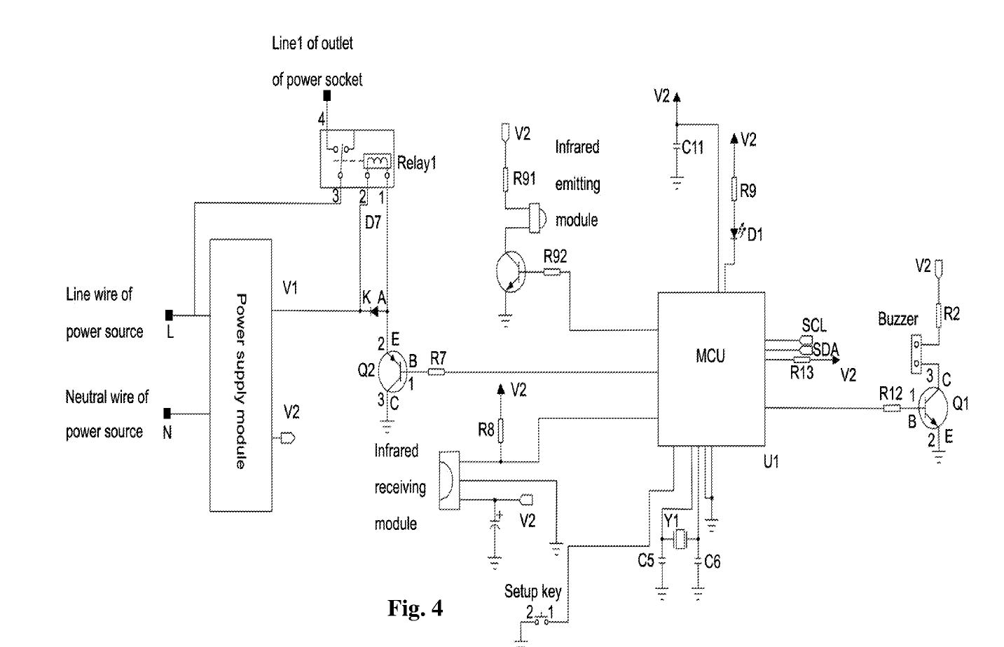

As shown in FIG. 2, the U1 inputs one way signal to the relay 1, the infrared emitting module 2, the indicator 3, and the buzzer 5, the infrared receiving module 8 and the setup key 6 input one way signal to the U1, the U1 and the mnemonic transmit two way signal to each other, the AC-DC power supply 9 supplies 12V direct current to V1 and 5V direct current to V2.

The operational principle of the power saving device of the present invention is: when the infrared receiving module receives signal from the infrared remote controller for a normal household appliance, the infrared receiving module reads the signal and convert it to an electronic code, and the monolithic processor accesses the electronic code by pushing the setup key simultaneously. When the power saving device receives the electronic code again, the monolithic processor executes the command to switch on or off the relay, the power terminal of the relay is connected in series with the live wire of the power source, so that the appliances connected to the power saving device will be powered off automatically when the relay is switched off.

In accordance with the power saving device of the present invention, an infrared remote controller for a normal household appliance can be used directly to switch on or switch off the relay of the device. By pushing the setup key, the device can read the signal from any key on the remote controller. The infrared signal is firstly converted to an electronic code via an infrared decoding module, and then is stored by the MCU. When pushing the same key on the remote controller, the MCU identifies this signal to switch off the relay; when pushing the same key of the remote control again, the MCU then switch on the relay. Moreover, by pushing a certain times of the setup key of a power saving device, a certain number of keys on the remote controller can be assigned to control a certain number of sockets on the plugboard. Further, in response to the function by pushing one key on the remote controller to power on or power off the appliances for power saving purpose, an infrared emitter can be installed on the power saving device, the microprocessor can control the codes stored before the infrared emitter emits.

What claimed is:

1. A power saving device, comprising
a microprocessor (U1);
an infrared receiving module;
a relay;
a buzzer;
an AC to DC power supply; and
an internal or external memory;
wherein
an infrared signal is emitted by pressing any key on the remote controller, and then the infrared receiving module reads this signal and converts this signal to an electronic code which is read and stored in memory by the U1 through pressing the setup key of the power saving device before pressing any key of the remote controller;
when the device receives the electronic code again, the U1 can execute the command to switch on or switch off the relay and drive the buzzer beep;
the AC power pins of the relay are connected in series between the line wire or neutral wire of the power source and outlets of power saving device, so that when the relay is switched off, the appliances connected to the outlet of the power saving device will be powered off simultaneously;
the power saving device is then ready to receive the infrared command;
the buzzer is drove by U1 to make users aware of the action of the relay for switch-on or switch-off;
by setting a setup key, an infrared receiving module and a relay connected to the U1, the U1 can read and store the infrared code when pressing the setup key, and then executes the action of switch-on or switch-off the relay according to the stored codes;
meanwhile, the U1 drives the buzzer to make indicative sound for users to recognize power-on or power-off of the outlets in the power saving device;
the AC power pins of the relay are connected in series between the power source and the outlets of the power saving device;
The U1 will switch on the relay after received the electronic code which is same to the stored code, and will not switch off the relay when received the same code again within a certain period of time after the relay is switched on; and
after this certain period of time, when the U1 receives the same electronic code again, the U1 will switch off the relay after several seconds delay.

2. A power saving device, comprising:
an interior memory built-in microprocessor (U1);
an infrared receiving module;
a relay;
a buzzer;
an AC to DC power supply; and
an internal or external memory,
wherein
an infrared signal is emitted by pressing any key on the remote controller, and then the infrared receiving module read this signal and converts this signal to an electronic code which is read and stored in memory by the U1 through pressing the setup key of the power saving device before pressing any key of the remote controller;
when the device receives the electronic code again, the U1 can execute the command to switch on or switch off the relay and drive the buzzer beep;
the AC power pins of the relay are connected in series between the line wire or neutral wire of the power source and outlets of power saving device, so that when the relay is switched off, the appliances connected to the power saving device will be powered off simultaneously;
the power saving device is then ready to receive the infrared command;
the buzzer is drove by U1 to make users aware of the action of the relay for switch-on or switch-off;
by setting a setup key, an infrared receiving module, and a relay connected to the U1, the U1 can read and store the infrared code when pressing the setup key, and then executes the action of switch-on or switch-off the relay according to the stored codes;
meanwhile, the U1 drives the buzzer to make indicative sound for users to recognize power-on or power-off of the outlet power in the power saving device; and
with another object equipped with Infra Red Receiving Module and the button of setup key, the body of the power saving device has a connector for signal connection and DC power supply, where the setup key and the infrared receiving module is under the control of U1 through a transmission line.

3. A power saving device, comprising
an interior memory built-in microprocessor (U1);
an infrared receiving module;
a relay;
a buzzer;
an AC to DC power supply; and
an external memory;
wherein
an infrared signal is emitted by pressing any key on the remote controller, and then the infrared receiving module read this signal and converts this signal to an electronic code which is read and stored in memory by the U1 through pressing the setup key of the power saving device before pressing any key of the remote controller;
when the device receives the electronic code again, the U1 can execute the command to switch on or switch off the relay and drive the buzzer beep;
the AC power pins of the relay are connected in series between the line wire or neutral wire of the power source and outlets of power saving device; so that when the relay is switched off, the appliances connected to the power saving device will be powered off simultaneously;
the power saving device is then ready to receive the infrared command;
the buzzer is drove by U1 to make users aware of the action of the relay for switch-on or switch-off;
by setting a setup key, an infrared receiving module, and a relay connected to the U1, the U1 can read and store the infrared code when pressing the setup key, and then executes the action of switch-on or switch-off the relay according to the stored codes;
meanwhile, the U1 drives the buzzer to make indicative sound for users to recognize power-on or power-off of the outlet power in the power saving device; and
with another object equipped with infrared receiving module, button of setup key and microprocessor U1, the body of the power saving device has a connector for signal connection and DC power supply, where the microprocessor U1 controls the relay and buzzer through a transmission line.

4. The power saving device of claim 1, wherein said a mute mode is available by optional cut off the power source of the buzzer by a switch button added on between the buzzer and DC power source.

5. The power saving device of claim 2 wherein said a mute mode is available by optional cut off the power source of the buzzer by a switch button added on between the buzzer and DC power source.

6. The power saving device of claim 3, wherein said a mute mode is available by optional cut off the power source of the buzzer by a switch button added on between the buzzer and DC power source.

7. The power saving device of claim 1, wherein said power saving device add an infrared transmitting module which can be controlled by U1.U1 will drive infrared transmitting module to emit Infra Red signal while U1 receives the code same as the stored code .U1 will not drive the infrared transmitting module to emit signal if the relay is in switch-on situation.

8. The power saving device of claim 2, wherein said power saving device add an infrared transmitting module which can be controlled by U1.U1 will drive infrared transmitting module to emit Infra Red signal while U1 receives the code same as the stored code .U1 will not drive the infrared transmitting module to emit signal if the relay is in switch-on situation.

9. The power saving device of claim 3, wherein said power saving device add an infrared transmitting module which can be controlled by U1.U1 will drive infrared transmitting module to emit Infra Red signal while U1 receives the code same as the stored code .U1 will not drive the infrared transmitting module to emit signal if the relay is in switch-on situation
